(19) United States
(12) Patent Application Publication
(10) Pub. No.: US 2002/0139561 A1
(43) Pub. Date: Oct. 3, 2002

(54) Flexible interconnect cable with ribbonized ends

(75) Inventors: Arthur Buck, Sherwood, OR (US); Malai Hongthong, Woodburn, OR (US); Cindy Lee Diegel, Sherwood, OR (US); Laurence A. Daane, Wilsonville, OR (US)

Correspondence Address: Bennet K. Langlotz PC, 2850 SW Fairmount Blvd., Portland, OR, 97201, US

(73) Assignee: Precision Interconnect Corporation

(21) Appl. No.: 09/822,550

(22) Filed: Mar. 30, 2001

(51) Int. Cl. H01B 11/02

(52) U.S. Cl. 174/113 R

(57) ABSTRACT

A cable assembly has a number of coaxial wires each having a central conductor and a surrounding shielding, and each having a first end and an opposed second end. The first ends of the wires are secured to each other in a flat ribbon portion in a first sequential arrangement, and the second ends of the wires are secured to each other in the same sequence as the first arrangement, with indicia identifying a selected wire in the sequence. The intermediate portions of the wires are detached from each other, and a sheath having a braided conductive shield loosely encompasses the wires, permitting significant flexibility of the cable.

### FIELD OF THE INVENTION

This invention relates to multiple wire cables, and more particularly to small gauge coaxial wiring.

### BACKGROUND AND SUMMARY OF THE INVENTION

Certain demanding applications require miniaturized multi-wire cable assemblies. To avoid undesirably bulky cables when substantial numbers of conductors are required, very fine conductors are used. To limit electrical noise and interference, coaxial wires having shielding are used for the conductors. A dielectric sheath surrounds a central conductor, and electrically separates it from the conductive shielding. A bundle of such wires is surrounded by a conductive braided shield, and an outer protective sheath.

Some applications requiring many different conductors prefer that a cable be very flexible, supple, or “floppy.” In an application such as a cable for connection to a medical ultrasound transducer, a stiff cable with even moderate resistance to flexing can make ultrasound imaging difficult. However, with conventional approaches to protectively sheathing cables, the bundle of wires may be undesirably rigid.

In addition, cable assemblies having a multitude of conductors may be time-consuming and expensive to assemble with other components. When individual wires are used in a bundle, one can not readily identify which wire end corresponds to a selected wire at the other end of the bundle, requiring tedious continuity testing. Normally, the wire ends at one end of the cable are connected to a component such as a connector or printed circuit board, and the connector or board is connected to a test facility that energizes each wire, one-at-a-time, so that an assembler can connect the identified wire end to the appropriate connection on a second connector or board.

A ribbon cable in which the wires are in a sequence that is preserved from one end of the cable to the other may address this particular problem. However, with all the wires of the ribbon welded together, they resist bending, creating an undesirably stiff cable. Moreover, a ribbon folded along multiple longitudinal fold lines may tend not to generate a compact cross section, undesirably increasing bulk, and may not provide a circular cross section desired in many applications.

The present invention overcomes the limitations of the prior art by providing a cable assembly having a number of coaxial wires each having a central conductor and a surrounding shielding, and each having a first end and an opposed second end. The first ends of the wires are secured to each other in a flat ribbon portion in a first sequential arrangement, and the second ends of the wires are secured to each other in the same sequence as the first arrangement, with indicia identifying a selected wire in the sequence. The intermediate portions of the wires are detached from each other, and a sheath having a braided conductive shield loosely encompasses the wires, permitting significant flexibility of the cable.

### BRIEF DESCRIPTION OF THE DRAWINGS

FIG. 1 is a perspective view of a cable assembly according to a preferred embodiment of the invention.

FIG. 2 is a perspective view of wiring components according to the embodiment of FIG. 1.

FIG. 3 is an enlarged sectional view of an end portion of a wiring component according to the embodiment of FIG. 1.

FIG. 4 is an enlarged sectional view of the cable assembly according to the embodiment of FIG. 1.

FIG. 5 is an enlarged sectional view of the cable assembly in a flexed condition according to the embodiment of FIG. 1.

### DETAILED DESCRIPTION OF A PREFERRED EMBODIMENT

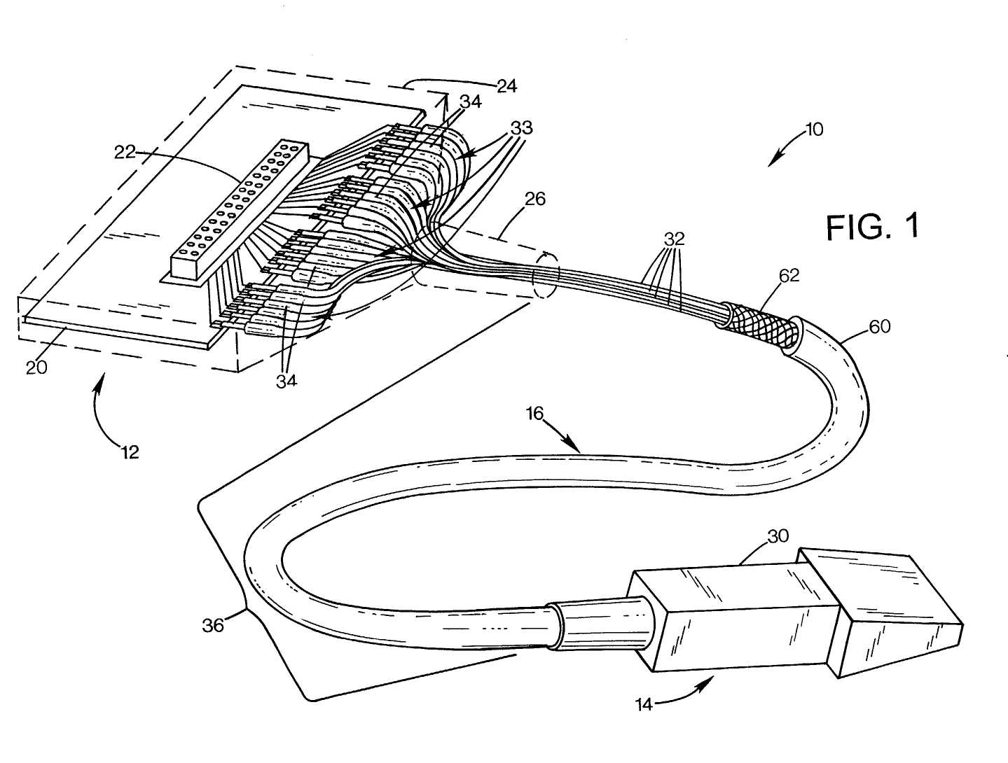

FIG. 1 shows a cable assembly 10 having a connector end 12, a transducer end 14, and a connecting flexible cable 16. The connector end and transducer ends are shown as examples of components that can be connected to the cable 16. In this example, the connector end includes a circuit board 20 with a connector 22 for connection to an electronic instrument such as an ultrasound imaging machine. The connector end includes a connector housing 24, and strain relief 26 that surrounds the end of the cable. On the opposite end, an ultrasound transducer 30 is connected to the cable.

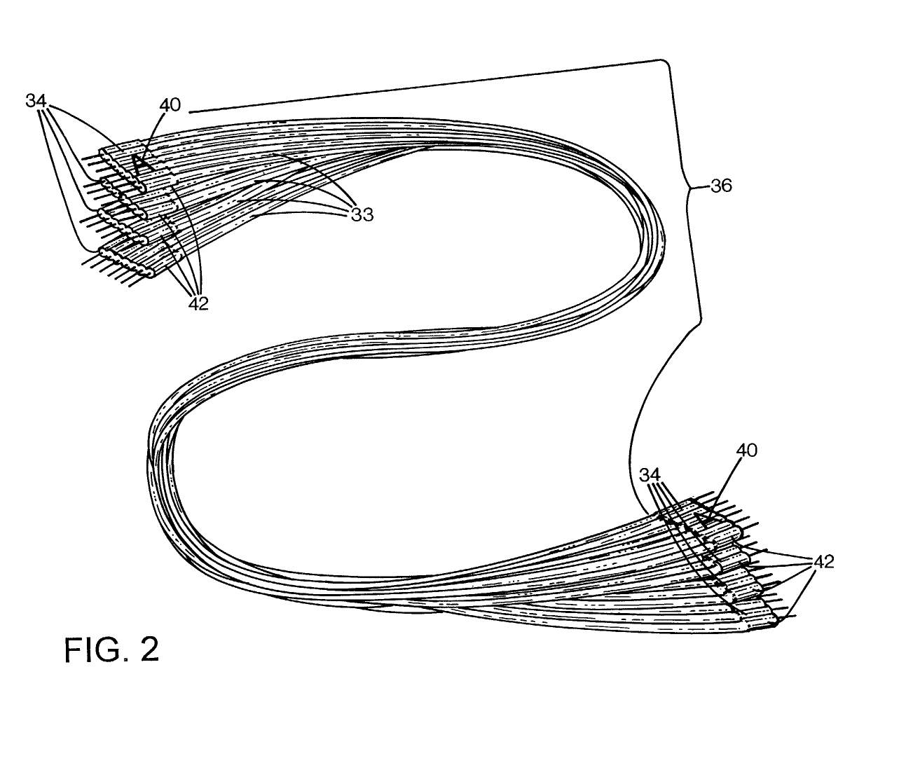

The cable 16 includes a multitude of fine coaxially shielded wires 32. As also shown in FIG. 2, the wires are arranged into groups 33, with each group having a ribbonized ribbon portion 34 at each end, and an elongated loose portion 36 between the ribbon portions and extending almost the entire length of the cable. Each ribbon portion includes a single layer of wires arranged side-by-side, adhered to each other, and trimmed to expose a shielding layer and center conductor for each wire. In the loose portion, the wires are unconnected to each other except at their ends.

The shielding and conductor of each wire are connected to the circuit board, or to any electronic component or connector by any conventional means, as dictated by the needs of the application for which the cable is used. The loose portions 36 of the wires extend the entire length of the cable between the strain reliefs, through the strain reliefs, and into the housing where the ribbon portions are laid out and connected.

The ribbon portions 34 are each marked with unique indicia to enable assemblers to correlate the opposite ribbon portions of a given group, and to correlate the ends of particular wires in each group. A group identifier 40 is imprinted on the ribbon portion, and a first wire identifier 42 on each ribbon portion assures that the first wire in the sequence of each ribbon is identified on each end. It is important that each group have a one-to-one correspondence in the sequence of wires in each ribbon portion. Consequently, an assembler can identify the nth wire from the identified first end wire of a given group “A” as corresponding to the nth wire at the opposite ribbon portion, without the need for trial-and-error continuity testing to find the proper wire. This correspondence is ensured, even if the loose intermediate portions 36 of each group are allowed to move with respect to each other, or with the intermediate portions of other groups in the cable.

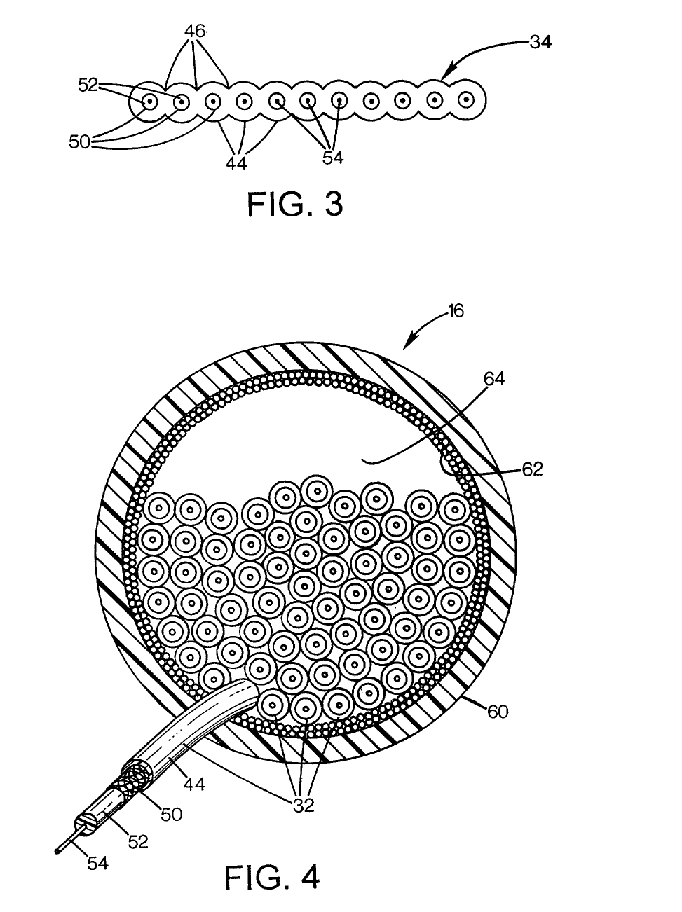

FIG. 3 shows a cross section of a representative end portion, with the wires connected together at their outer sheathing layers 44 at weld joints 46, while the conductive shielding 50 of each of the wires remains electrically isolated from the others, and the inner dielectric 52 and central conductors 54 remain intact and isolated. In alternative embodiments, the ribbon portions may be secured by the use of adhesive between abutting sheathing layers 44, by adhesion of each sheathing layer to a common strip or sheet, or by a mechanical clip.

FIG. 4 shows the cable cross section throughout most of the length of the cable, away from the ribbon portions, reflecting the intermediate portion. The wires are loosely contained within a flexible cylindrical cable sheath 60. As also shown in FIG. 1, a conductive braided shield 62 surrounds all the wires, and resides at the interior surface of the sheath to define a bore 64.

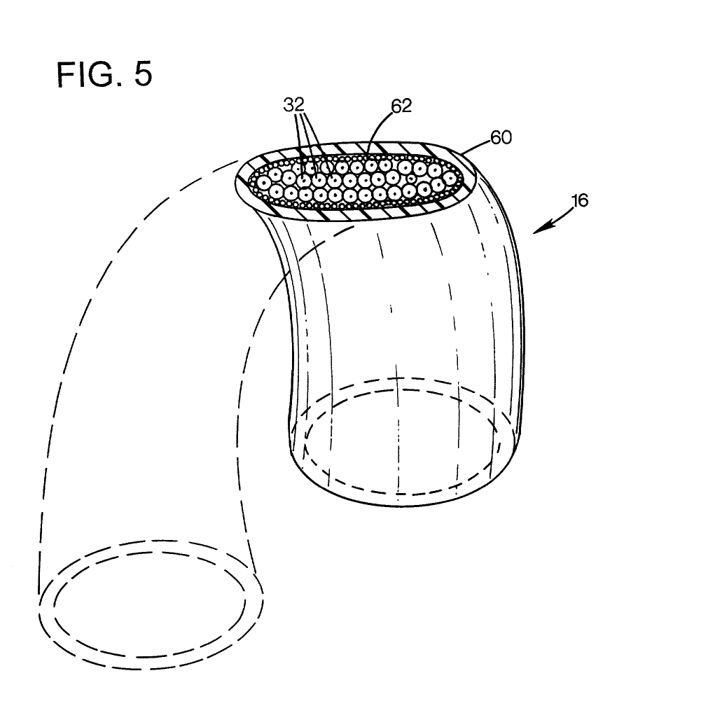

Returning to FIG. 4, the bore diameter is selected to be somewhat larger than required to closely accommodate all the wires. This provides the ability for the cable to flex with minimal resistance to a tight bend, as shown in FIG. 5, as the wires are free to slide to a flattened configuration in which the bore cross section is reduced from the circular cross section is has when held straight, as in FIG. 4.

In the preferred embodiment, there are 8 groups of 16 wires each, although either of these numbers may vary substantially, and some embodiments may use all the wires in a single group. The wires preferably have an exterior diameter of 0.016 inch, although this and other dimensions may range to any size, depending on the application. The sheathing has an exterior diameter of 0.330 inch and a bore diameter of 0.270 inch. This yields a bore cross section (when straight, in the circular shape) of 0.057 inch. As the loose wires tend to pack to a cross-sectional area only slightly greater than the sum of their areas, there is significant extra space in the bore in normal conditions. This allows the wires to slide about each other for flexibility, and minimizes wire-to-wire surface friction that would occur if the wires were tightly wrapped together, such as by conventional practices in which a wire shield is wrapped about a wire bundle. In the preferred embodiment, a bend radius of 0.75 inch, or about 2 times the cable diameter, is provided with minimal bending force, such as if the cable is folded between two fingers and allowed to bend to a natural radius. Essentially, the bend radius, and the supple lack of resistance to bending is limited by little more than the total bending resistance of each of the components. Because each wire is so thin, and has minimal resistance to bending at the radiuses on the scale of the cable diameter, the sum of the wire's resistances adds little to the bending resistance of the sheath and shield, which thus establish the total bending resistance.

While the above is discussed in terms of preferred and alternative embodiments, the invention is not intended to be so limited.

1. A cable assembly comprising:
a plurality of wires, each having a first end and an opposed second end;
the first ends of the wires being secured to each other in a first sequential arrangement;
the second ends of the wires being secured to each other in a second sequential arrangement based on the first arrangement; and
the wires having intermediate portions between the first and second ends, the intermediate portions being detached from each other.

2. The cable assembly of claim 1 wherein the first and second ends are ribbonized.

3. The cable assembly of claim 1 wherein the first ends of the wires are arranged in parallel, adjacent to each other, in a selected sequence, and the second ends of the wires are arranged in parallel, adjacent to each other, in the selected sequence.

4. The cable assembly of claim 3 including indicia on the first end and on the second end, identifying respective ends of a first wire in the sequence.

5. The cable assembly of claim 1 including a plurality of sets of wires, the wires being secured within each set, and the sets being detached from each other.

6. The cable assembly of claim 5 including an indicia on each end of each set of wires, identifying the set of wires to distinguish it from other sets of wires.

7. The cable assembly of claim 1 wherein each of the wires is a coaxial wire having a central conductor and a surrounding shielding.

8. The cable assembly of claim 1 wherein each wire includes an insulating sheath isolating the conductors of the wires from each other.

9. The cable assembly of claim 8 wherein the sheaths are connected to each other at the ends.

10. The cable assembly of claim 1 including a sheath encompassing all the wires, and wherein the intermediate portions of the wires are loosely received within the sheath.

11. The cable assembly of claim 10 wherein the sheath includes an inner braided shield about the intermediate portions.

12. A cable assembly comprising:
a plurality of wires, each having a first end and an opposed second end;
the wires having intermediate portions between the first and second ends, the intermediate portions being detached from each other;
a sheath encompassing all the wires, and wherein the intermediate portions of the wires are loosely received within the sheath.

13. The cable assembly of claim 12 wherein the sheath defines a bore having a diameter greater than a closely constrained bundle diameter of the intermediate portions.

14. The cable assembly of claim 12 wherein the sheath includes an inner braided conductive shield about the intermediate portions.

15. The cable assembly of claim 14 wherein the shield defines an inner surface of the sheath.

16. The cable assembly of claim 12 wherein the assembly is operable to generate a flattened cross section when flexed substantially.

17. The cable assembly of claim 12 wherein the first ends of the wires are secured to each other in a first sequential arrangement and the second ends of the wires are secured to each other in a second sequential arrangement based on the first arrangement.

18. The cable assembly of claim 12 wherein the first and second ends are ribbonized.

19. The cable assembly of claim 12 wherein each of the wires is a coaxial wire having a central conductor and a surrounding shielding.

20. A cable assembly comprising:
a plurality of coaxial wires each having a central conductor and a surrounding shielding, and each having a first end and an opposed second end;
the first ends of the wires being secured to each other in a flat ribbon portion in a first sequential arrangement;
the second ends of the wires being secured to each other in a flat ribbon portion in a second sequential arrangement in the same sequence as the first arrangement;
the wires having intermediate portions between the first and second ends, the intermediate portions being detached from each other;
the first end and the second end including indicia identifying a first wire in the sequence; and
a sheath including a braided conductive shield loosely encompassing the wires.
